(19) United States
(12) Patent Application Publication
(10) Pub. No.: US 2023/0408809 A1
(43) Pub. Date: Dec. 21, 2023

(54) CAPACITIVE SENSING

(71) Applicant: Hewlett-Packard Development Company, L.P., Spring, TX (US)

(72) Inventors: Robert Paul Martin, Fort Collins, CO (US); Fred Charles Thomas, III, Fort Collins, CO (US)

(73) Assignee: Hewlett-Packard Development Company, L.P., Spring, TX (US)

(21) Appl. No.: 18/250,970

(22) PCT Filed: Oct. 29, 2020
(86) PCT No.: PCT/US2020/058060

§ 371 Date: Apr. 27, 2023

(51) Int. Cl. G02B 27/00; G02B 27/01; G06F 3/01

(52) U.S. Cl. CPC G02B 27/0093; G02B 27/017; G06F 3/012; G02B 2027/0187

(57) ABSTRACT

A wearable apparatus for sensing movement of a wearer's body is disclosed. The wearable apparatus comprises a flexible substrate for conforming about the wearer's body, and a capacitive sensor attached to the flexible substrate, the capacitive sensor comprising a transmitter electrode and a receiver electrode arranged in opposition on opposite sides of the flexible substrate, the transmitter electrode being arranged to capacitively couple to the receiver electrode.

### BACKGROUND

Capacitive sensing refers to detecting a change in capacitance of a capacitive sensor. Capacitive sensors may be configured to exhibit a change in capacitance in response to direct electrical contact with, or proximity to, a large capacitive object, such as a person's finger, or in response to a change in geometry of the capacitive sensor, such as spacing or area variation between conductive plates of the capacitive sensor. Capacitive sensors may thereby be deployed to sense contact or proximity of an object to the sensor, for example as a touch-sensitive sensor for sensing a human input to a human-machine interface of an electronic device, or to sense and quantify load or pressure applied to the sensor, for example as a load sensor for sensing movement of an object contacting the capacitive sensor.

### BRIEF DESCRIPTION OF THE DRAWINGS

FIG. 1 shows a virtual-reality (VR) headset embodying an example of the present disclosure;

FIG. 2 shows an elevation view of a wearer-facing side of the VR headset;

FIG. 3 shows a side cross-sectional view of the VR headset through the plane A-A identified in FIG. 2;

FIG. 4 shows a flexible substrate of the VR headset having a plurality of capacitive sensors;

FIG. 5 shows an example architecture of the plurality of capacitive sensors;

FIG. 6 shows the flexible substrate and one of the capacitive sensors in a side cross-sectional view;

FIGS. 7a and 7b depict relative movements of the electrodes of the capacitive sensor;

FIGS. 8a, 8b and 8c show capacitive sensors of the plurality of capacitive sensors;

FIG. 9 shows an example implementation of the architecture of FIG. 5, comprising a Sigma-delta converter for converting signals output by the sensors;

FIG. 10 shows an example implementation of the Sigma-delta converter of FIG. 9;

FIG. 11 shows processes of an example method embodying the disclosure; and

FIG. 12 shows an example apparatus embodying the present disclosure.

### DETAILED DESCRIPTION

In the following description, for purposes of explanation, numerous specific details of certain examples are set forth. Reference in the specification to “an example” or similar language means that a particular feature, structure, or characteristic described in connection with the example is included in at least that one example, but not necessarily in other examples.

There are many applications in which it is desirable to sense movement of a human or animal body. For example, it may be desirable to sense movement of a person's face to sense biometric/expressivity characteristics, or to sense movement of a person's body tissues for medical monitoring.

One way to sense body movement is using an electromyography (EMG) technique, whereby electrodes are applied to the body to sense electrical enervation and thus movement of muscle cells. This approach relies on electrical contact being maintained between the electrodes and the wearer's skin during use. Further, in this approach, signals from the sensors may have a low signal to noise ratio, and it may thus be complicated to extract accurate enervation information from the reading.

The present disclosure describes methods and systems useful for sensing movement of a human or animal body via capacitive sensors. Capacitive sensing of body movement has an advantage compared to EMG in that the sensing system may be relatively less susceptible to misreading caused by separation of the sensors from the body during use. A further advantage of capacitive sensing is the relative ease by which a signal may be extracted from a noisy reading.

In aspects of the present disclosure, an array of capacitive sensors comprising respective pairs of transmitter and receiver electrodes, e.g. conductive plates, are attached to a flexible substrate, e.g. a fabric and/or elastomer substrate. For each capacitive sensor, the electrodes are arranged in opposition on opposite sides of the flexible substrate, such that the electrodes are mutually capacitively coupled. The capacitance of each capacitive sensor in the array is a function of the geometry of the capacitive sensor, e.g. the spacing between the electrodes and/or the area overlap of the electrodes. Loads exerted on the flexible substrate may be expected to vary the geometry of capacitive sensors in the array. For example, compressive loads may reduce the spacing between the electrodes, thereby increasing the capacitance of the respective capacitive sensor(s). Conversely, shear loads exerted on the flexible substrate may cause the conductive layers of capacitive sensors to become mutually misaligned, i.e. to reduce the area overlap between the conductive layers, and thereby reduce the capacitance of the respective capacitive sensor.

The flexible substrate, carrying the capacitive sensors, may be conformed about a body region, for example, about a person's face. Movement of the body may thus exert load, e.g. stretching or compressive loads on the flexible substrate. These loads may be transferred by the flexible substrate to the capacitive sensors in the array. By measuring the capacitances of capacitive sensors, variations in the capacitances may be sensed. Relative movement of the conductive layers of the capacitive sensors may thereby be determined, and by inference movement of the body about which the flexible substrate is conformed. Measurements of changes in capacitance of capacitive sensors in the array may allow the position, magnitude and direction of the load, and so the movement of the body, to be determined.

The substrate may be flexible to allow its conformance around contours of a body. Further the flexibility of the substrate may allow relative movement between conductive layers of each capacitive sensor in response to loading on the flexible substrate. For example, the flexible substate may advantageously be flexible such as to allow compressive and shear movement between conductive layers of the capacitive sensors. The flexible substrate may advantageously be elastomeric to best allow such relative movement of the conductive layers of the capacitive sensors.

An example of an apparatus in which aspects of the present disclosure find utility is in virtual reality (VR) eyewear, e.g. a VR headset, for use in a VR environment. In this implementation, the apparatus may be deployed for sensing movements of the wearer's facial muscles, such that the wearer's avatar in a virtual environment, such as a video game or a video conference, may be animated to express the wearer's facial expressions.

Another example implementation of an apparatus embodying aspects of the present disclosure is a medical monitoring device for monitoring, e.g. a wearer's pulse rate, where the wearer's pulse rate may be inferred by sensing movements of a part of the wearer's body, for example, a finger or wrist. In such an alternative application the wearable apparatus could form a clothing garment, a belt, a glove or a cuff, for example.

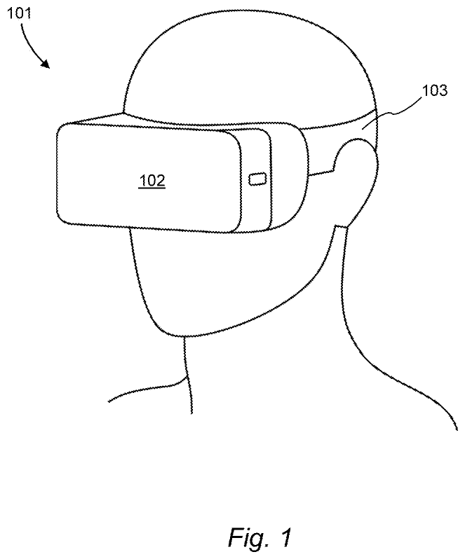

FIG. 1 shows an example application of a wearable apparatus embodying the present disclosure, in the form of VR headset 101, which is adapted to be worn as eyewear on a wearer's head. VR headset comprises goggles 102 for location in front of the wearer's eyes, and a strap 103 for strapping the goggles 102 to the wearer's head. As will be described, goggles 102 house a stereoscopic display for displaying video imagery to the wearer. Such video imagery could, for example, comprise video game, or video conference, imagery. The VR headset 101 may thus provide an immersive video experience to the wearer.

As will be described further with reference to later Figures, in examples, the VR headset 101 comprises sensors for sensing movement of the wearer's face. In examples, the VR headset comprises capacitive sensors for sensing movement of upper regions of the wearer's face, e.g. regions surrounding the wearer's eyes. In examples, the VR headset 101 further comprises an optical sensor for sensing movement of lower regions of the wearer's face, e.g. the wearer's mouth. Movement data captured by these various sensors may be utilised by a system hosting the video environment in which the wearer is participating, e.g. a video game or video conference, and may be used to animate the wearer's avatar in the video environment with the wearer's facial expressions. The wearer's interaction with the video environment may thereby be improved.

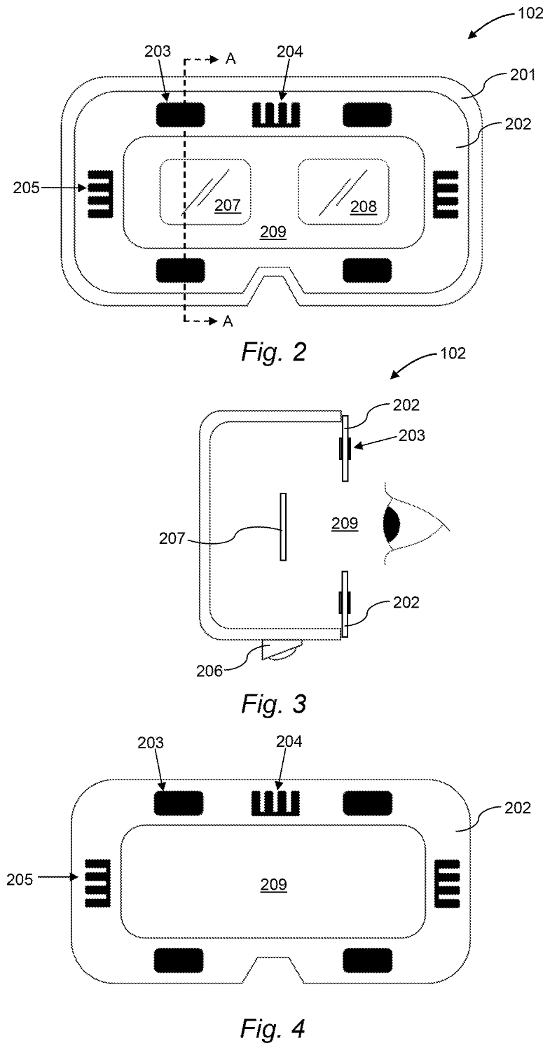

FIGS. 2 and 3 show the goggles 102 of VR headset 101. The goggles 102 comprise housing 201, flexible substrate 202, a plurality of capacitive sensors, such as capacitive sensors 203, 204 and 205, optical camera 206, and electronic displays 207, 208. FIG. 4 shows the flexible substrate 202, and the plurality of capacitive sensors 203 to 205. In other examples, flexible substrate 202 may comprise a single capactive sensor, for example, sensor 203.

Housing 102 is generally cuboid in shape, with a hollow interior and an open front. The electronic displays 207, 208, which in examples are liquid-crystal displays, are located in the hollow interior of the housing. The electronic displays are deployed for displaying stereoscopic video imagery to the wearer, for example, for displaying video game or video conference imagery. In other examples the electronic displays 207, 208 could be other types of electronic display, e.g. LED displays.

The flexible substrate 202 is mounted to the open front of the of the housing 201 to partially close the open front. The flexible substrate 202 is adapted to contact and conform about the wearer's face when the VR headset 101 is worn by a wearer. In examples, the flexible substrate 202 is adapted to conform about forehead, eye, and upper cheek regions of a wearer's face. In examples, the flexible substrate 202 is generally annular in shape, and defines an aperture 209, through which the electronic displays 207, 208 may be viewed by a wearer when the VR headset 101 is worn by the wearer.

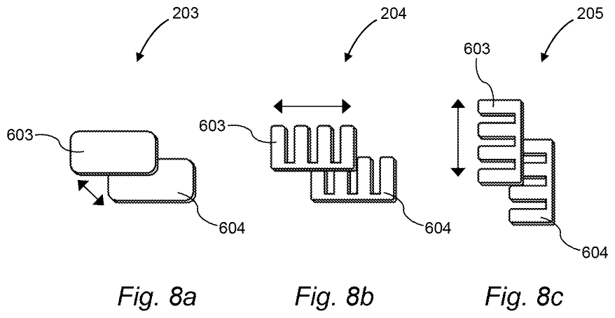

The plurality of capacitive sensors 203 to 205 are attached to the flexible substrate 202. As will be described with reference to later Figures, in operation, wherein the VR headset 101 is mounted to a wearer's head, and the flexible substrate 202 is conformed about the eye region of the wearer's face, the plurality of capacitive sensors, e.g. sensors 203 to 205, are controlled for sensing movement of the wearer's face, for example, for sensing frowning of the wearer's face. Apparatus according to the disclosure may utilise any number of capacitive sensors. In examples, the apparatus may utilise a single capacitive sensor, e.g. sensor 203. An advantage of this approach is that processing of capacitance data from a single sensor may be relatively simpler and less computationally expensive that processing data from multiple sensors. However, a disadvantage of this approach is a reduced amount of information relating to the body movement, and thus a reduced ability to characterise the body movement, e.g. to characterise the particular type of facial expression. In examples therefore, apparatus embodying the disclosure may comprise a plurality of capacitive sensors, which may thereby allow fuller characterisation of a sensed body movement, as will be described further with reference to FIGS. 8a to 8b.

In examples, the VR headset 101 comprises one or more optical cameras 206. Optical camera 206 is mounted to the housing 201 of the goggles 102, and arranged to image a wearer's mouth when the VR headset 101 is worn by a wearer. The optical camera 206 may thus be deployed, using suitable imaging circuitry, to image the wearer's mouth and/other lower facial regions of the wearer's face in use. Such imaging may be utilised, by suitable control means, to sense movement of the wearer's mouth/lower facial regions, for example, to sense the wearer smiling.

The capacitance data from the capacitive sensors 203 to 205, optionally along with image data from the camera(s) 206 may, as previously described, be utilised by a system hosting the video environment in which the wearer is participating, to animate the wearer's avatar in the video environment with the wearer's facial expressions.

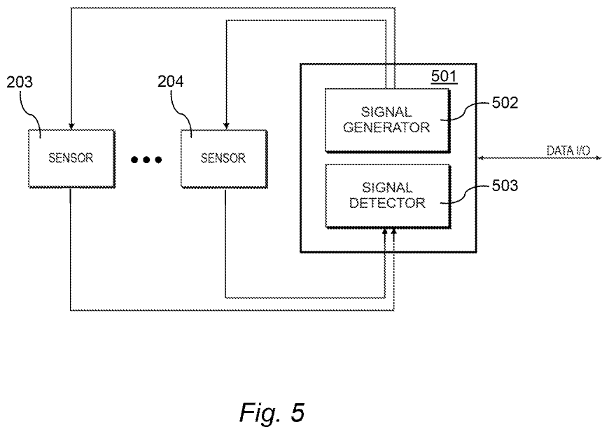

FIG. 5 shows an example architecture of each of the capacitive sensors 203 to 205 in block diagram form. For each capacitive sensor 203 to 205 a controller 501 provides a signal generator 502 and a signal detector 503. The signal generator 502 is coupled to the respective sensor and configured to generate an excitation signal. The signal detector 503 is coupled to the sensor and is configured to generate an output signal in reaction to the excitation signal.

The controller 501 allows data acquisition and provides data in/out functionality via, for example, a USB controller (not shown), so as to allow data to be shared with connected devices such as, for example, a computer housing a video game or video conference session.

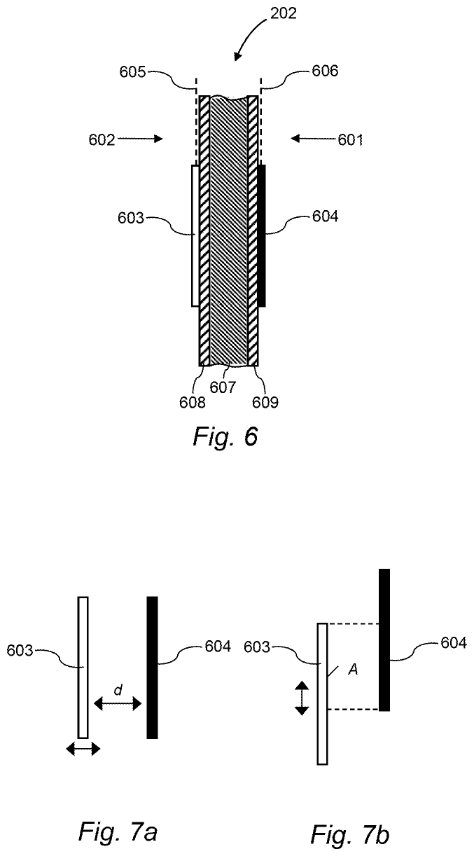

FIG. 6 shows the flexible substrate 202 and capacitive sensor 203 in cross section. The flexible substrate 203 comprises a near-side 601 intended for facing the wearer's body in use, and an away-side side 602 intended for facing away from the wearer's body in use.

Each capacitive sensor of the plurality, such as capacitive sensor 203, comprises a transmitter electrode 603 and a receiver electrode 604. The convention of representing transmitter electrodes with a white fill, and receiver electrodes with a black fill will be adhered to throughout the accompanying figures. In examples, the transmitter and receiver electrodes are each generally planar, thereby forming conductive plates. The transmitter electrode 603 and the receiver electrode 604 are arranged in opposition on mutually opposite sides of the flexible substrate 202. The transmitter electrode 603, due to its proximity, capacitively couples to the receiver electrode 604 when a voltage is applied. In examples, the transmitter electrode 603 is arranged on the away-side 602 of the flexible substrate. This may reduce the degree of capacitive coupling, and so charge leakage, of the transmitter electrode 603 to the wearer's body in use. In such examples, the receiver electrode 604 is arranged on the near-side 601 of the flexible substrate 202. Conductors 605, 606 are provided to electrically couple the electrodes 603, 604 respectively to the controller 501, e.g. to electrically couple the transmitter electrode 603 to the signal generator 502, and the receiver electrode 604 to signal detector 503. The conductors 605, 606 are arranged on the away and near sides respectively of the flexible substrate 202.

The flexibility of the flexible substrate 202 allows the substrate 202 to conform about the body region for which movement is to be sensed, e.g. the wearer's face, such that the flexible substrate 202 may be deformed by movement of the wearer's body region, to thereby load the plurality of capacitive sensors 203 to 205. The flexible substrate 202 thus functions to transfer load from the wearer's body to the capacitive sensors, and also to mechanically couple the capacitive sensors. In examples, the flexible substrate 202 is multi-layer, and may comprise an inner elastomer layer 607 and first and second outer fabric layers 608, 609 respectively. The elastomer layer 607 may comprise silicone. Alternative materials such as neoprene could be used for the elastomer layer 607. A function of the elastomer layer 607 is to be highly deformable, e.g. resiliently compressible and stretchable. A function of the fabric layers 608 to 609 is to protect the elastomer layer 607, and/or to provide a finish to the flexible substrate that is aesthetically pleasing and/or comfortable against a wearer's skin.

The electrodes 603, 604 of the capacitive sensors and/or the conductors 605, 606 may be flexible. Configuring the electrodes and/or the conductors to be flexible may advantageously allow better conformance of the flexible substrate 202 about the wearer's body. In examples, the electrodes 603, 604 of the capacitive sensors and/or the conductors 605, 606 may comprise electrically conductive material printed onto the substrate 202. In alternative examples, the electrodes 603, 604 and/or the conductors 605, 606 may comprise conductive foil traces, and/or multi-strand wires.

The flexible substrate 202 may comprise any number of layers of material. For example, the flexible substrate may comprise a single material layer, e.g. a single layer of fabric, or a single layer of an elastomer. As a further alternative example, the flexible substrate 202 could comprise additional layers of material, e.g. outer layers to cover the electrodes 603, 604 and the conductors 605, 606.

FIGS. 7a and 7b show the electrodes 603, 604 of the capactive sensor 203. The flexible substrate 202 is adapted to deform when loaded in result of movement of the wearer's body, to thereby result in relative movement between the transmitter and receiver electrodes of each of the capacitive sensors 203 to 205. Variations in the geometry of each capacitive sensor, e.g. changes in spacing or area overlap between transmitter and receiver electrode of each capacitive sensor will result in a change in the degree of capacitive coupling between the electrodes, and thereby a change in capacitance of the respective capacitive sensor. Such a change in capacitance of each capacitive sensor may be sensed and optionally quantified by the controller 501. Thus, a change in capacitance of one or more of the capacitive sensors 203 to 205 may be detected, from which movement of the wearer's body may be inferred. Pre-calibration of the controller 501, or later image processing stages, with capacitance-facial expression relationships may thereby conveniently allow for sensing of a wearer's facial expression.

Referring in particular to FIG. 7a, the elastomer layer 607 of the flexible substrate 202 allows the capacitive sensors to be compressed, i.e. for the spacing ‘d’ between the transmitter and receiver electrodes to be reduced, in response to pressure exerted on the near-side 601 of the flexible substrate, or on the receiver electrode 604 directly, by the wearer's body. Such a pressure on the flexible substrate 202 or the receiver electrode 604 may be expected to occur in result of the wearer adopting a particular facial expression. This reduction in spacing between the transmitter and receiver electrodes 603, 604 results in an increase in the degree of capacitive coupling between the transmitter and receiver electrodes. Thus, for the same excitation voltage applied to the transmitter electrode 603, a higher voltage will be developed at the receiver electrode 604 when a compressive force is applied to the flexible substrate 202 and/or the receiver electrode 604.

Referring in particular to FIG. 7b, the elastomer layer 607 of the flexible substrate 202 further allows for lateral relative movement between the transmitter and receiver electrodes 603, 604 in response to shear loading on the flexible substrate. Such shear loading may occur as a result of bending of the flexible substrate 202 by movement of the wearer's body. Such relative lateral movement of the transmitter and receiver electrodes 603, 604 varies the degree of area overlap of the electrodes, i.e. the alignment of the electrodes is decreased or increased. This variation in area overlap/misalignment of the electrodes of the capacitive sensor results in a corresponding variation in capacitive coupling between the transmitter and receiver electrodes. For example, referring to FIG. 7b, a downward movement of transmitter electrode 603 relative to receiver electrode 604 will reduce the area overlap of the electrodes, and so reduce the capacitive coupling therebetween, and vice versa. Thus, in the example, for the same excitation voltage applied to the transmitter electrode 603, a lower voltage will be developed at the receiver electrode 604 when a shear force is applied to the flexible substrate 202.

In examples, the transmitter and receiver electrodes 603, 604 of one or more of the capacitive sensors 203 to 205, are adapted to have matched areas, i.e. the area of the transmitter electrode of a sensor is substantially the same as the area of the receiver electrode of that sensor. Referring to the issue over area overlap illustrated in FIG. 7b, this configuration has the advantage that the greatest variation in overlap/degree of misalignment between the transmitter and receiver electrodes may be expected to result from a given deformation of the flexible substrate. Consequently, the capacitive coupling between the transmitter and receiver electrodes, and so the capacitance of the capacitive sensor, may be expected to vary most significantly in response to deformation of the flexible substrate, i.e. in result of movement of the wearer's body. As a result, the variation in capacitance may be more easily sensed by the controller, and in particular, assuming a given noise in the signal output by the receiver electrode, the signal-to-noise ratio of the signal output by the receiver electrode may be greatest. Accordingly, movement of the wearer's body may be sensed more precisely and accurately in this configuration. In contrast, if an electrode of one of the capacitive sensors were substantially smaller than the other electrode of that sensor, it may be possible for a relatively high degree of relative lateral movement to occur between the electrodes with minimal or no variation in area overlap, and so capacitive coupling, of the electrodes.

FIGS. 8a to 8c show the electrodes 603, 604 of capacitive sensors 203 to 205 in isolation.

In examples, the capacitive sensors 203 to 205 are configured such that their respective transmitter and receiver electrodes are mutually differently shaped between the capacitive sensors. Thus, in the example, referring to the Figures, the transmitter and receiver electrodes 603, 604 of capacitive sensor 203 are each substantially rectangular, whilst the transmitter and receiver electrodes 603, 604 of capacitive sensors 204, 205 are generally comb-shaped, comprising a ‘bus’ and elongate ‘finger’ portions extending orthogonally from the bus. Moreover, in examples, the capacitive sensors 204, 205 are arranged on the flexible substrate in mutually different orientations. In the example, capacitive sensor 204 is arranged in a notional ‘horizontal’ orientation, in which the fingers extend vertically, whilst capacitive sensor 205 is arranged in a notional ‘vertical’ orientation, in which the fingers extend horizontally.

The differences in electrode shape and/or orientation between the capacitive sensors 203 to 205 has the effect that the degree of capacitive coupling between respective transmitter and receiver electrodes of the capacitive sensors, i.e. and so the capacitive responses of the capacitive sensors, may be expected to be mutually different for a same relative movement between respective transmitter and receiver electrodes. This circumstance has the practical advantage that, by measuring the capacitances of a plurality of the relatively different capacitive sensors, it may be possible to determine not only that a relative movement between transmitter and receiver electrodes of one or more of the capacitive sensors has occurred, but also the direction of such relative movement, e.g. up-down, left-right or compressive, thereby allowing better characterisation of the movement of the wearer's body, e.g. the wearer's facial expression.

By way of explanation, referring to capacitive sensor 203, having generally rectangular transmitter and receiver electrodes 603, 604, the degree of capacitive coupling, between the electrodes, and so in use the capacitance of the sensor, will vary in response to a variation in the distance between the plates, e.g. as a result of a compressive load, and also in response to a variation in the area overlap of the electrodes, e.g. as a result of a shear load. Thus, sensation by the controller 501 of a change in capacitance of capacitive sensor 203 may allow the reliable conclusion that relative movement between the electrodes 603, 604 has occurred. Such a sensation may not however typically itself allow accurate characterisation of the type of movement, i.e. shear or compressive, and accordingly would not allow characterisation of the nature of the body movement, e.g. the facial expression.

Referring to capacitive sensor 204 as depicted in FIG. 8b, the comb-like shape of the transmitter and receiver electrodes 603 to 604 has the result that the degree of capacitive coupling between the transmitter and receiver electrodes, and so the capacitance of the sensor, may be expected to vary more greatly in response to left-right relative movement of the electrodes, resulting in variation in area overlap of the electrodes, than to compressive movement resulting in variation in the spacing between the electrodes. This is because a small left-right misalignment of the comb-shaped electrodes 603, 604 of sensor 204 may cause the ‘fingers’ of the electrodes to become almost completely misaligned, i.e. to overlap to a minimal extent, thereby resulting in a relatively large variation in capacitive coupling between the electrodes. In contrast, the degree of area overlap of the electrodes 603, 604, and so the capacitive coupling therebetween, may be expected to be varied less markedly by relative up-down movement of the electrodes.

And, referring to capacitive sensor 205 depicted in FIG. 8c, the area overlap, and so degree of capacitive coupling of the electrodes 603, 604, may be expected to be relatively highly varied by up-down relative movement of the electrodes. Accordingly, the capacitive coupling, and so capacitance, of the sensor 205 may be expected to be relatively highly varied in response to up-down relative movement of the electrodes. In contrast, the degree of area overlap of the electrodes 604, 605, and so the capacitive coupling therebetween, may be expected to be varied less markedly by relative left-right movement of the electrodes.

Consequently, the capacitive responses of the sensors 203 to 205 may tend to be mutually different when subjected to a same relative movement between their respective transmitter and receiver electrodes, as may occur in result of a body movement. Such mutually different capacitive responses of the sensors may advantageously allow for fuller characterisation of body movements. For example, a left-right running shear stress exerted on the flexible substrate may be expected to relatively highly vary the capacitance of sensor 204, whilst relatively lowly varying the capacitance of sensor 205. These capacitances may be measured by controller 501, and accordingly a determination may be made that side-side movement of the body region, e.g. the face, has occurred. This characteristic may be compared by the controller to predefined characterisation data to predict the nature of the body movement, e.g. the type of facial expression.

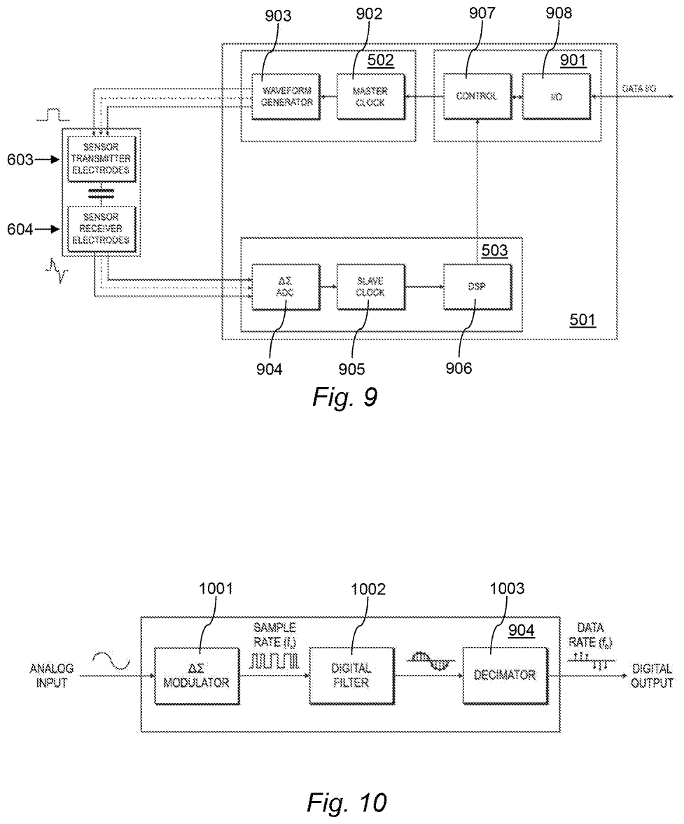

FIG. 9 shows schematically an approach to implementing the architecture of FIG. 5 for the plurality of capacitive sensors 203 to 205. In addition to signal generator 502 and signal detector 503, controller 501 further comprises interface module 901 for interfacing the controller with other computing devices.

In examples, signal generator 502 comprises a master clock circuit 902, and a waveform generator 903. The master clock circuit generates a high speed and highly accurate clock, which in examples is set to a rate in the order of hundreds of hertz (Hz), e.g. 300 Hz. Other clock frequencies could of course be used depending upon the temporal accuracy required. The master clock 902 is provided to waveform generator 903 which is capable of generating a sequence of rectangular waves, for example, square waves, which are supplied to the respective transmitter electrodes 603 of the plurality of sensors 203 to 205. In alternative examples, the waveform generator 903 could be configured to generate saw tooth or sinusoidal waves for supply to the transmitter electrode. In examples, the waveform generator 903 is constructed from an operational amplifier in an astable multivibrator topology. Alternatively, the waveform generator 903 could be constructed with a 1-bit digital-to-analog converter and a word generator clocked to the master clock 502. In examples, the waveform generator includes a respective connection to each one of the transmitter electrodes of the sensors 203 to 205. In alternative examples, an output of the waveform generator could be supplied to a demultiplexer for applying waves to the transmitter electrodes.

The signals from the waveform generator 903 cause energy transfer between the respective transmitter and receiver electrodes 603, 604 of each sensor 203 to 205, via the electric field between them. The extent of energy transfer is determined, as described previously, by the degree of capacitive coupling between the respective transmitter and receiver electrodes of each capacitive sensor, which is in turn a function of the geometries of the sensor, e.g. the electrode spacing and/or area overlap, and so the load on the capacitive sensors. Thus, an output signal is developed at the receiver electrode 604 of each sensor, which is provided to the signal detector 503. Similarly, in examples the signal detector may include a respective connection to each of the receiver electrodes 604 of the sensors 203 to 205. As an example alternative, where the input signal to the transmitter electrode is multiplexed, the signal detector may be coupled to the receiver electrodes of the sensor by a multiplexer for multiplexing outputs of the sensors.

In examples, signal detector 503 comprises a Sigma-delta analog-to-digital converter 904, a slave clock circuit 905, and a digital signal processor 906.

Initially the output signal from the receiver electrodes 604 is supplied to the Sigma-delta analog-to-digital converter 904, which functions as a 1-bit sampling system. The slaved clock 905 is synchronised with the master clock 902, and is provided to the Sigma-delta analog-to-digital converter 904 to set the sampling rate to the same rate as the waveform generator of the signal generator 502, e.g. 300 Hz. The Sigma-delta analog-to-digital converter 904 converts the analog signals output by the receiver electrodes of the sensors to respective digital signals. In examples, the Sigma-delta analog-to-digital converter 904 may be implemented by a multi-channel circuit device, and all channels may be driven and read in parallel. Alternatively, the channels may be driven and read sequentially.

The digital output of the Sigma-delta analog-to-digital converter 904 is provided to digital signal processor 906 for further processing of the signal data. The processed digital signal is then provided to control unit 907 of interface module 901 for output, via input/output device 908, to an external computing device, e.g. to a remote server hosting a video game or conference session.

FIG. 10 shows schematically an approach to implementing the Sigma-delta analog-to-digital converter 904 of FIG. 9. In examples, the Sigma-delta analog-to-digital converter 904 comprises Sigma-delta modulator 1001, digital filter 1002 and decimator 1003. Alternative configurations of the Sigma-delta analog-to-digital converter are possible in alternative examples.

Initially the signals received from the receiver electrodes of the sensors are provided to Sigma-delta modulator 1001. The input signals are time-varying analog voltages. The Sigma-delta modulator 1001 is responsible for digitizing the analog input signal and reducing noise at lower frequencies. Sigma-delta modulator 1001 implements a function called noise shaping that pushes low frequency noise up to higher frequencies where it is outside the band of interest. To do this, the Sigma-delta modulator coarsely samples the input signal at a very high rate, e.g. 300 Hz, into a 1-bit stream. Suitable architectures for Sigma-delta modulator 1001 will be known to the person skilled in the art. The Sigma-delta modulator 1001 is effective at reducing low-frequency noise during the conversion process, but the output signal of the Sigma-delta modulator will still contain high frequency noise. Higher frequency noise may be reduced by the digital filter and decimator stages 1002, 1003.

The output of the Sigma-delta modulator 1001 is a high-speed, 1-bit output rate containing high-frequency noise. Once the signal lies in the digital domain, a low-pass digital-filter function may be used to attenuate the high-frequency noise. The digital filter 1002 implements the low-pass filter by first sampling the modulator stream of the 1-bit code. Suitable low-pass filter architectures will be known to the person skilled in the art. In the frequency domain, the digital filter applies a low-pass filter to the signal. In so doing, it attenuates the modulator's quantization noise; but it also reduces the frequency bandwidth. With the quantization noise reduced, the signal re-emerges in the time domain. The output of the digital filter 1002 is thus a high-resolution, de-noised, digital version of the input signal. But the output rate of the digital filter, being the same as the sampling rate, may still be undesirably high.

The output of the digital filter 1002 may thus be supplied to the decimation filter 1003. In the decimation circuit, the digital signal's output rate is reduced by discarding some of the samples to thereby reduce the output data. Suitable architectures for decimation filter 1003 will be known to the person skilled in the art. The digital filter 1002 and decimation filter 1003 thus together reduce high-frequency noise in the voltage signals output by the receiver electrodes, and output digital representations of the input signals a reduced data rate.

The output of the decimation filter 1003 is supplied to the control device 907. The control device 907 may thus output the signal, via input/output device 901 to a connected device. In examples, all of the functionality of controller 501 is implemented onboard VR headset 101, by suitable circuitry located in the VR headset. In other examples, part of the functionality of controller 501 is implemented onboard the headset 101.

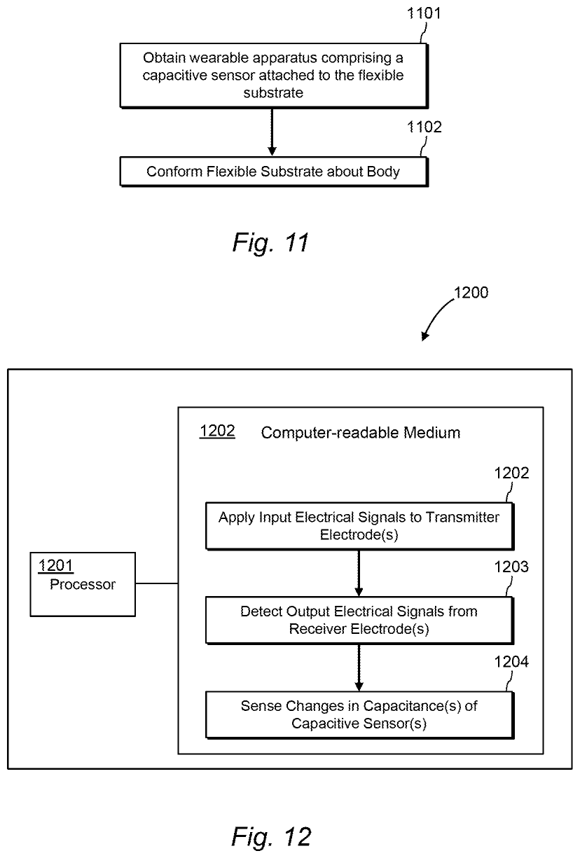

Referring to FIG. 11, a method of using a wearable apparatus according to the present disclosure, such as wearable apparatus 101 described with reference to FIGS. 1 to 10, comprises two stages. Stage 101 involves obtaining the wearable apparatus. Stage 1102 involves mounting the wearable apparatus to the body to conform the flexible substrate around the body.

According to examples, machine-readable instructions may, for example, be executed by a general-purpose computer, a special purpose computer, an embedded processor or processors of other programmable data processing devices to realize functions described in the description and diagrams. In particular, a processor or processing apparatus may execute the machine-readable instructions. Thus, modules of apparatus may be implemented by a processor executing machine-readable instructions stored in a memory, or a processor operating in accordance with instructions embedded in logic circuitry. The term ‘processor’ is to be interpreted broadly to include a CPU, processing unit, ASIC, logic unit, or programmable gate set etc. The methods and modules may all be performed by a single processor or divided amongst several processors.

Such machine-readable instructions may also be stored in a computer readable storage that can guide the computer or other programmable data processing devices to operate in a specific mode. For example, machine-readable instructions may be provided on a non-transitory computer readable storage medium encoded with instructions, executable by a processor.

FIG. 12 shows an apparatus embodying an example of the disclosure. Apparatus 1200 comprises processor 1201 and computer-readable medium 1202. The computer-readable medium 1202 comprises machine-readable instructions which are executable by the processor 1201.

The machine-readable instructions stored on computer-readable medium 1202 cause the processor to: at stage 1202, apply input electrical signals to the transmitter electrode(s) of the one or more capacitive sensors; at stage 1203, detect output electrical signals from receiver electrode(s) of the one or more capacitive sensors; and at stage 1204, sense changes in capacitance(s) of the one or more capactive sensors.

Such machine-readable instructions may also be loaded onto a computer or other programmable data processing devices, so that the computer or other programmable data processing devices perform a series of operations to produce computer-implemented processing, thus the instructions executed on the computer or other programmable devices provide an operation for realizing functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the present disclosure. In particular, a feature or block from one example may be combined with or substituted by a feature/block of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A wearable apparatus for sensing movement of a wearer's body, the wearable apparatus comprising:
a flexible substrate for conforming about a wearer's body, and
a capacitive sensor attached to the flexible substrate, the capacitive sensor comprising a transmitter electrode and a receiver electrode arranged in opposition on opposite sides of the flexible substrate, the transmitter electrode being arranged to capacitively couple to the receiver electrode.

2. The apparatus of claim 1, wherein the flexible substrate is elastomeric.

3. The apparatus of claim 1, wherein the transmitter electrode and the receiver electrode have a substantially same area.

4. The apparatus of claim 1, wherein the transmitter electrode and the receiver electrode are flexible.

5. The apparatus of claim 1, wherein the transmitter electrode and the receiver electrode comprise conductive ink printed on the flexible substrate.

6. The apparatus of claim 1, comprising flexible conductors attached to the flexible substrate to electrically couple the transmitter electrode and the receiver electrode to a controller for controlling the capacitive sensor.

7. The apparatus of claim 1, comprising a controller for controlling the capacitive sensor, wherein the controller comprises a signal generator operable to generate input electrical signals and apply the input electrical signals to the transmitter electrode, and a signal detector operable to detect output signals from the receiver electrode.

8. The apparatus of claim 7, wherein the signal detector further comprises a capacitance sensing circuit for sensing changes in capacitance of the capacitive sensor.

9. The apparatus of claim 1, wherein the transmitter electrode is arranged on a side of the flexible substrate opposite to a side of the flexible substrate which faces the wearer when the wearable apparatus is worn by a wearer.

10. The apparatus of claim 1, comprising a plurality of the capacitive sensors attached to the flexible substrate.

11. The apparatus of claim 10, comprising a controller for controlling the plurality of capacitive sensors, wherein the controller comprises a signal generator operable to generate input electrical signals and apply the input electrical signals to transmitter electrodes of the plurality of capacitive sensors, and a signal detector operable to detect individually output signals from receiver electrodes of the plurality of capacitive sensors.

12. The apparatus of claim 10, wherein capacitive sensors of the plurality are configured to have mutually different capacitive responses to a mutually same relative movement between the transmitter and receiver electrodes of the respective capacitive sensor.

13. The apparatus of claim 10, wherein the apparatus comprises eyewear comprising an electronic display, the flexible substrate defines an aperture around which the plurality of capacitive sensors are arranged, the apparatus is configured when the eyewear is worn by a wearer to support the flexible substrate in contact with the wearer's face such that the aperture defined by the flexible substrate is located in front of an eye of the wearer and such that the electronic display is viewable by the wearer through the aperture.

14. A method for sensing movement of a wearer's body using a wearable apparatus, the method comprising:
conforming a flexible substrate of the wearable apparatus about a wearer's body, the flexible substrate comprising a capacitive sensor attached to the flexible substrate, the capacitive sensor comprising a transmitter electrode and a receiver electrode arranged in opposition on opposite sides of the flexible substrate,
applying, using a signal generator, input electrical signals to the transmitter electrode of the capacitive sensor to cause the transmitter electrode to capacitively couple to the receiver electrode of the capacitive sensor,
detecting, using a signal detector, output electrical signals from the receiver electrode, and
sensing, using a capacitance sensing circuit, changes in capacitance of the capacitive sensor.

15. A non-transitory computer readable medium for the head mounted display assembly of claim 1, the non-transitory computer readable medium comprising instructions which are executable by a processor, to cause the processor to:
apply input electrical signals to the transmitter electrode of the capacitive sensor to cause the transmitter electrode to capacitively couple to the receiver electrode of the capacitive sensor,
detect output electrical signals from the receiver electrode, and
sense changes in capacitance of the capacitive sensor.
